(19) United States
(12) Patent Application Publication
(10) Pub. No.: US 2012/0200074 A1
(43) Pub. Date: Aug. 9, 2012

(54) Magnetic Spine Binding

(76) Inventors: Michael Kuch, New York, NY (US); Joseph Riedel, Hadley, MA (US)

(21) Appl. No.: 13/364,324

(22) Filed: Feb. 2, 2012

Related U.S. Application Data
(60) Provisional application No. 61/439,033, filed on Feb. 3, 2011.

(51) Int. Cl. B42D 5/00; B42C 99/00

(52) U.S. Cl. 281/21.1; 412/6

(57) ABSTRACT

A book structure and method for constructing a spine of a book, using a magnetic field created through the adhesion of magnets to hold together the book block at the spine and to allow the book spine to be separated at any page to expand the book partially or fully like an accordion. The magnets are adhered to the pages and/or to the front and back cover boards using glue or adhesive and may be covered with thin strips of material for additional strength. The resulting book spine holds together but can easily be separated for viewing spread out for exhibition.

### WRITTEN DESCRIPTION OF THE INVENTION

The purpose of this invention is to allow the user of an accordion book to have a choice as to the mode of display. The invention allows the user to either expand the book to view some or all of the images on the pages at one time. The invention also permits the user to contract the book so that it has a functioning spine, permitting the user to turn the pages without them coming apart without the user's intention.

In a preferred embodiment, super-strength magnets, such as neodymium magnets are used to bind the spine of an accordion book. Traditionally accordion book spines are sewn or not sewn. If they are not sewn the pages can fall from the covers while viewing it in one's hands. If the book is sewn, the book cannot be viewed stretched out, which is useful for display in exhibitions. With this invention, super-strength magnets replace the thread for sewing. This holds the pages together at the spine, but they can also be easily detached for viewing spread-out for exhibition.

The features of this invention can be understood by reference to the accompanying drawings. These drawings illustrate a preferred embodiment of the invention. FIG. 1 shows a perspective view of an accordion book that is expanded and up right, as if the bottom edge were resting on a surface. This view shows how the book might be displayed for exhibition of all or some of the images at once. From this perspective, the viewer is looking at the backside of the pages. The backside will not be visible while viewing the book's images. This illustration shows an accordion book with five pages and a front and back cover, though there is not preferred page limit. Each page has a verso (1) and recto (2), the verso being the left side and the recto being the right side while reading. The backside of each verso page (1a) and the backside of each recto page (2a) are facing the viewer of this illustration:

On the back of the gutter end of each page, a thin, super strength magnet is adhered (as by glue) in each of the following places: near the fold on the backside of the recto at the top edge (3) and near the fold on the backside of the recto at the bottom edge (3a.) and adhered near the fold on the backside of the verso, at the top edge (4) and near the fold at the backside of the verso at the bottom edge (4a). Thus when the magnetics are brought close together they attract, causing these folds to become the spine. On the back of the front cover board (5a), a thin super strength magnet is adhered near the spine edge at the top edge (6) and at the bottom edge (6a). On the back of the back cover board (7a), a thin super strength magnet is adhered near the spine edge at the top edge (8) and the bottom edge (8a). The polarity of all of the magnets in the invention should remain in the same direction throughout the spine of the book.

FIG. 2 shows a perspective view of an accordion book with the magnetic spine in an unexpanded mode, as if the bottom edge were resting on a surface. The face of the front cover (5) is displayed and the face of the back cover (7) is displayed. This demonstrates how the invention holds the pages in place along the spine. This permits a reader to turn the pages of an accordion book without it expanding unless the reader uses deliberate force to pull the pages apart.

### BRIEF DESCRIPTION OF THE DRAWINGS

FIG. 1 illustrates a side view of an accordion book with the magnetic spine binding, expanded and upright, as if the bottom edge were resting on a surface according to one aspect of the present disclosure; and

FIG. 2. illustrates a side view of an accordion book with the magnetic spine binding, in an unexpanded mode, according to another aspect of the present disclosure.

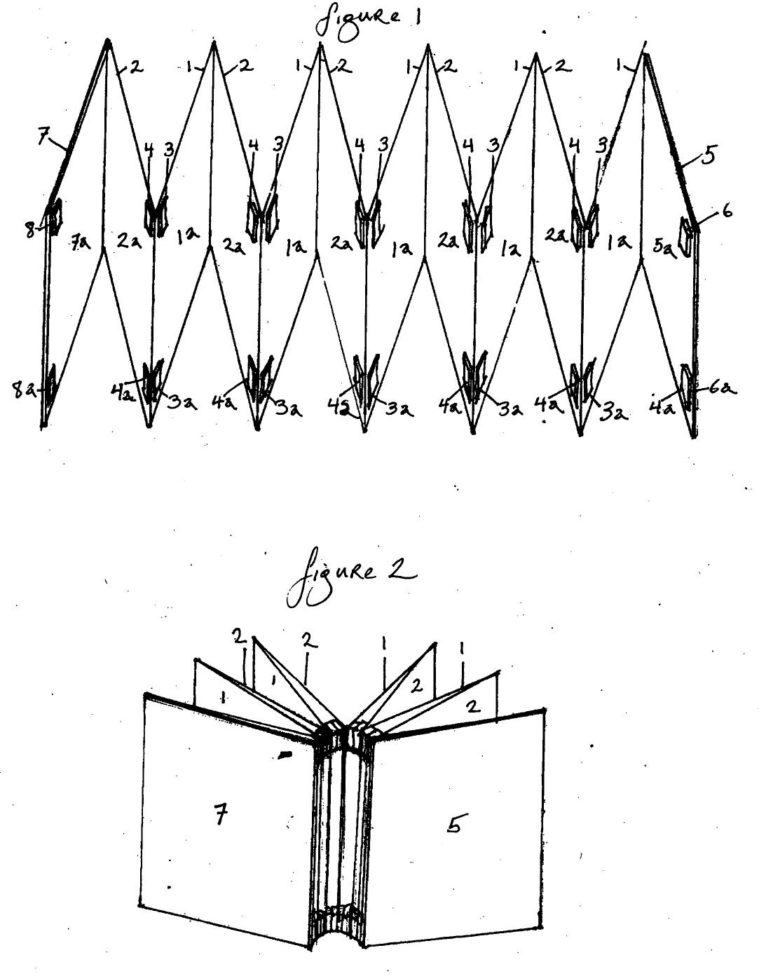

### ILLUSTRATION KEY

1: Verso
1a: Back of verso
2: Recto
2a: Back of recto
3, 3a, 4, 4a, 6, 6a, 8, 8a: Super-strength magnets
5: Face of front cover board
5a: Back of front cover board
7: Face of back cover board
7a: Back of back cover board

I claim:

1. A book structure, comprising:
a. a plurality of pages forming a book block;
b. magnets adhered near the spine edge of said pages; and
c. which adhered magnets create a magnetic field that holds together the book block at the spine.

2. The book structure of claim 1, wherein each such page other than the last is attached to the subsequent page at the fore edge, allowing the book spine to be separated at any page to expand the book partially or fully like an accordion.

3. The book structure of claim 1, comprising magnets adhered near the spine edge of the front and back cover boards;

4. The book structure of claim 1, wherein each such page other than the last is attached to the subsequent sheet at the fore edge, allowing the book spine to be separated at any page to expand the book partially or fully like an accordion and comprising magnets adhered near the spine edge of the front and back cover boards;

5. The book structure of claim 1, wherein a thin strip of material covers the magnets, and adheres to the pages.

6. The book structure of claim 3, wherein a thin strip of material covers the magnets, and adheres to the pages and cover boards.

7. A method for constructing a spine of a book, comprising:
a. assembling a plurality of pages to form a book block;
b. adhering magnets to the spine edge of the pages of said book block; and
c. creating a magnetic field that holds together the book block at the spine.

8. A method for constructing a spine of a book of claim 7, comprising attaching each such page other than the last to the subsequent page at the fore edge, allowing the book spine to be separated at any page to expand the book partially or fully like an accordion.

9. A method for constructing a spine of a book of claim 7, comprising adhering magnets near the spine edge of the front and back cover boards.

10. A method for constructing a spine of a book of claim 8, comprising adhering magnets near the spine edge of the front and back cover boards.

11. The method for constructing a spine of a book of claim 7, comprising adhering magnets
a. near the fold on the backside of the recto at the top edge, near the fold on the backside of the recto at the bottom edge, near the fold on the backside of the verso, at the top edge, and near the fold at the backside of the verso at the bottom edge; and
b. such that the polarity of all magnets remain in the same direction.

12. The method for constructing a spine of a book of claim 8, comprising adhering magnets
a. near the fold on the backside of the recto at the top edge, near the fold on the backside of the recto at the bottom edge, near the fold on the backside of the verso, at the top edge, and near the fold at the backside of the verso at the bottom edge; and
b. such that the polarity of all magnets remain in the same direction.

13. The method for constructing a spine of a book of claim 7, comprising adhering magnets
a. on the back of the front cover board, a thin super strength magnet is adhered near the spine edge at the top edge, and at the bottom edge;
b. on the back of the back cover board, a thin super strength magnet is adhered near the spine edge at the top edge and the bottom edge;
c. such that the polarity of all magnets remain in the same direction.

14. The method for constructing a spine of a book of claim 8, comprising adhering magnets
a. near the fold on the backside of the recto at the top edge, near the fold on the backside of the recto at the bottom edge, near the fold on the backside of the verso, at the top edge, and near the fold at the backside of the verso at the bottom edge;
b. on the back of the front cover board, a thin super strength magnet is adhered near the spine edge at the top edge, and at the bottom edge;
c. on the back of the back cover board, a thin super strength magnet is adhered near the spine edge at the top edge and the bottom edge;
d. such that the polarity of all magnets remain in the same direction.

15. The method for constructing of a book of claim 7, wherein a thin strip of material covers the magnets, and adheres to the pages.

16. The method for constructing of a book of claim 9, wherein a thin strip of material covers the magnets, and adheres to the pages.
